(19) United States
(12) Patent Application Publication
(10) Pub. No.: US 2006/0056147 A1
(43) Pub. Date: Mar. 16, 2006

(54) Electronic apparatus and latch structure thereof

(75) Inventor: Chien Ying Chen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/219,699

(22) Filed: Sep. 7, 2005

(30) Foreign Application Priority Data
Sep. 14, 2004 (TW) 093127692

(51) Int. Cl. G06F 1/16

(52) U.S. Cl. 361/685

(57) ABSTRACT

A latch structure is for fixing a detachable electronic assembly, which at least has a hole. The latch structure has a casing, a latch member, and at least a fixing member. In this case, the casing has at least a first opening, at least a second opening, and a limit portion. The limit portion is adjacent to the first opening. The latch member has an engaging portion, and at least a fixing portion. One part of the fixing member passes through the fixing portion and the hole so as to fix the latch member to the detachable electronic assembly. When the engaging portion engages with the second opening, another part of the fixing member is positioned at the limit portion.

### BACKGROUND OF THE INVENTIONS

1. Field of Invention

The invention relates to an electronic apparatus and its latch structure. In particular, the invention relates to an electronic apparatus using a latch structure to fix a detachable electronic assembly and the latch structure thereof.

2. Related Art

In the information era, the hard disk drive (HDD) is one of the most important storage devices in a computer. It provides cheap, high-speed and large-capacity storage space for storing the operating system, application programs, and user's data

In addition to the HDD, another data storage device is the optical information storage media. To access such media, one has to use an optical disk drive. Therefore, both the HDD and the optical disk drive are important devices in a computer.

A normal detachable HDD or optical disk drive is first fixed on a cage that is part of the host. As shown in FIG. 1, the conventional detachable HDD 11 is accommodated in a cage 12. The sides of the cage 12 have several screw holes 121 corresponding to the fixing holes 111 on the sides of the HDD 11. Therefore, the HDD 11 can be fixed in the cage 12 using screws 13.

However, the mounting and release of the detachable HDD 11 rely on the use of many screws 13. This does not only waste the assembly time and lower the production speed, but the screws also cost a lot.

It is therefore an important subjective of the invention to provide an electronic apparatus and a latch structure, which need fewer screws and are easily assembled.

### SUMMARY OF THE INVENTION

In view of the foregoing, the invention is to provide an electronic apparatus and a latch structure thereof, which- can fix a detachable electronic assembly on a casing without using screws.

To achieve the above, a latch structure of the invention, which is used for fixing a detachable electronic assembly with at least one hole, includes a casing, a latch member, and at least one fixing member. In this case, the casing has at least a first opening, at least a second opening, and a limit portion. The limit portion is adjacent to the first opening The latch member has an engaging portion, and at least a fixing portion. One part of the fixing member passes through the fixing portion and the hole, which is for fixing the latch member to the detachable electronic assembly. When the engaging portion engages with the second opening, another part of the fixing member is positioned at the limit portion.

To achieve the above, an electronic device of the invention includes a detachable electronic assembly, a casing, a latch member, and at least one fixing member. The detachable electronic assembly has at least one hole. In this case, the casing has at least a first opening, at least a second opening, and a limit portion. The limit portion is adjacent to the first opening. The latch member has an engaging portion, and at least a fixing portion. One part of the fixing member passes through the fixing portion and the hole, which is for fixing the latch member to the detachable electronic assembly. When the engaging portion engages with the second opening, another part of the fixing member is positioned at the limit portion.

As mentioned above, the electronic apparatus and its latch structure of the invention utilize a fixing member and a latch member to fix the detachable electronic assembly on the casing. In comparison with the prior art, when the detachable electronic assembly is pushed into the casing, the fixing member on the detachable electronic assembly enters the first opening, positioned on the limit portion. At the same time, the engaging portion on the latch member enters the second opening, fixing the detachable electronic assembly inside the casing. Since the invention reduces or even avoids the use of screws, a lot of time for mounting screws and the cost for them can be saved. Moreover, the user can remove the detachable electronic assembly simply by pressing the latch member. Thus, the user does not need to mount dismount screws when fixing or releasing the detachable electronic assembly. It is very convenient and simple. One also does not need to worry if he or she loses the screws for fixing.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional detachable HDD;

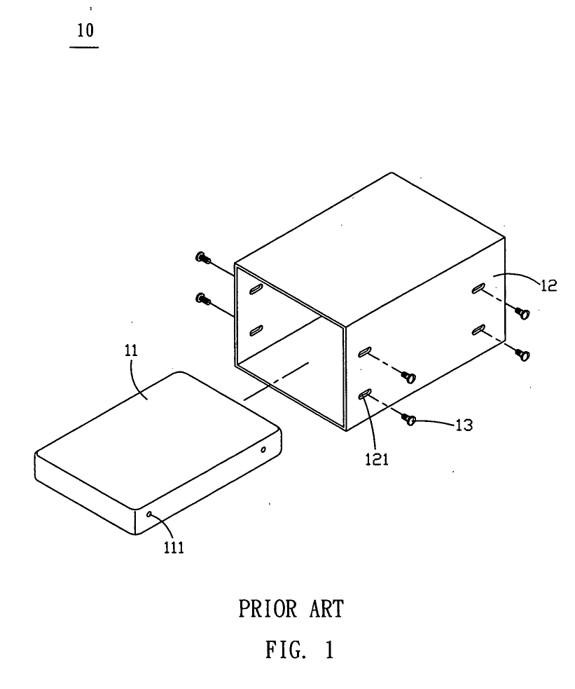

FIG. 2 is an exploded view of an electronic apparatus and a latch structure according to a preferred embodiment of the invention;

FIG. 3 is a schematic view of the electronic apparatus and latch structure according to the preferred embodiment of the invention;

FIG. 4 is another schematic view of the electronic apparatus and latch structure according to the preferred embodiment of the invention, wherein the fixing member enters the first opening along the guiding member;

FIG. 5 is yet another schematic view of the electronic apparatus and latch structure according to the preferred embodiment of the invention, wherein the detachable electronic assembly is fixed on the casing; and

FIG. 6 is yet another schematic view of the electronic apparatus and latch structure according to the preferred embodiment of the invention, wherein the holding portion of the latch member is pressed for the engaging portion to leave the second opening.

### DETAILED DESCRIPTION OF THE INVENTION

The present invention will be apparent from the following detailed description, which proceeds with reference to the accompanying drawings, wherein the same references relate to the same elements.

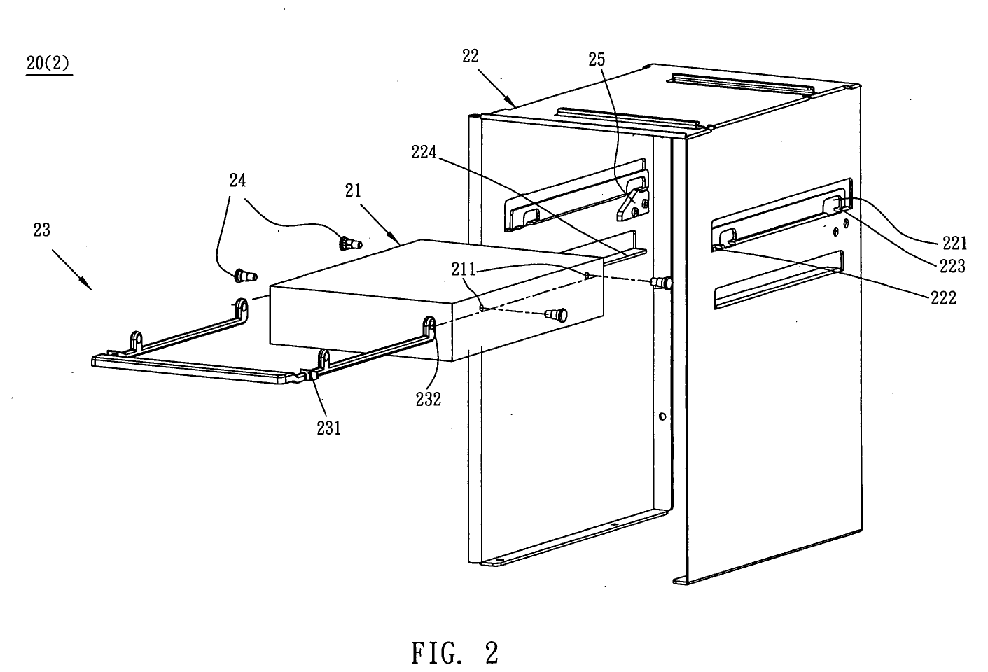

First, please refer to FIGS. 2 to 6 for illustrating a latch structure according to a preferred embodiment of the invention.

The latch structure 20 is used for fixing a detachable electronic assembly 21, which has at least one hole 211. The detachable electronic assembly 21 can be an HDD or an optical disk drive. In this embodiment, the detachable electronic assembly 21 is, for example, an HDD.

With reference to FIG. 2, a latch structure 20 includes a casing 22, a latch member 23, and at least one fixing member 24.

The casing 22 has at least a first opening 221, at least a second opening 222, and a limit portion 223. The limit portion 223 is adjacent to the first opening 221 and can be formed on the casing 22 by a punch process. In this embodiment, the casing 22 has several first openings 221 and several second openings 222. The casing 22 can accommodate at least a detachable electronic assembly 21. In this embodiment, a single detachable electronic assembly 21, such as a hard disk, is accommodated in the casing 22.

Besides, the casing 22 has at least a support bar 224, installed adjacent to the first opening 221 and the second opening 222. In this embodiment, the casing 22 has two supporting bars 224. The detachable electronic assembly 21 can slide in the casing 22 with the supporting bars 224.

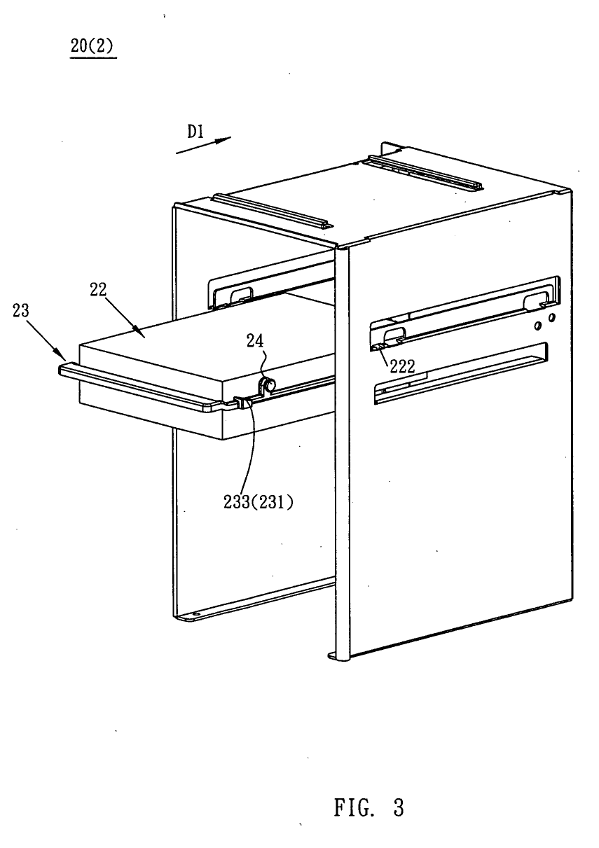

The latch member 23 is connected to the detachable electronic assembly 21. It has an engaging portion 231 and at least a fixing portion 232. As shown in FIG. 3, the engaging portion 231 has a slant surface 233. When the detachable electronic assembly 21 moves along a first direction D1, the engaging portion 231 engages with the second opening 222 via the slant surface 233.

With reference to FIGS. 2 and 3, one part of the fixing member 24 passes through the fixing portion 232 and the hole 211 of the detachable electronic assembly 21 to fix the latch member 23 to the detachable electronic assembly 21. In this embodiment, the fixing portion 232 can be a hole 211 and the fixing member 24 can be a screw or rivet.

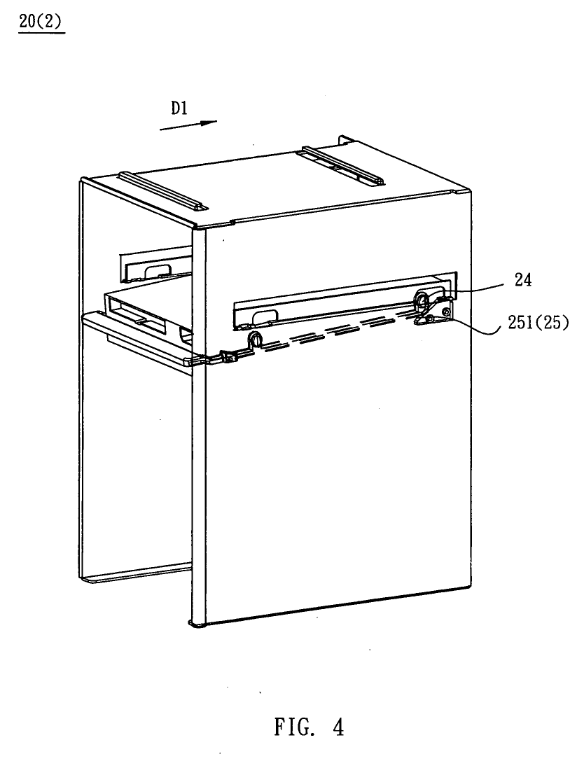

Referring to FIGS. 2 and 4 again, the latch structure 20 of the embodiment further includes a guiding member 25 provided adjacent to the first opening 221. It can be made of a metal, plastic or rubber. The guiding member 25 has a guiding surface 251. When the detachable electronic assembly 21 moves along the first direction D1, the fixing member 24 also moves. Once the fixing member 24 touches the guiding surface 251, the fixing member 24 enters the first opening 221 along the guiding surface 251. The first direction D1 and the guiding surface 251 subtend an angle. Therefore, the detachable electronic assembly 21 is lifted as the fixing member 24 moves along the guiding surface 251.

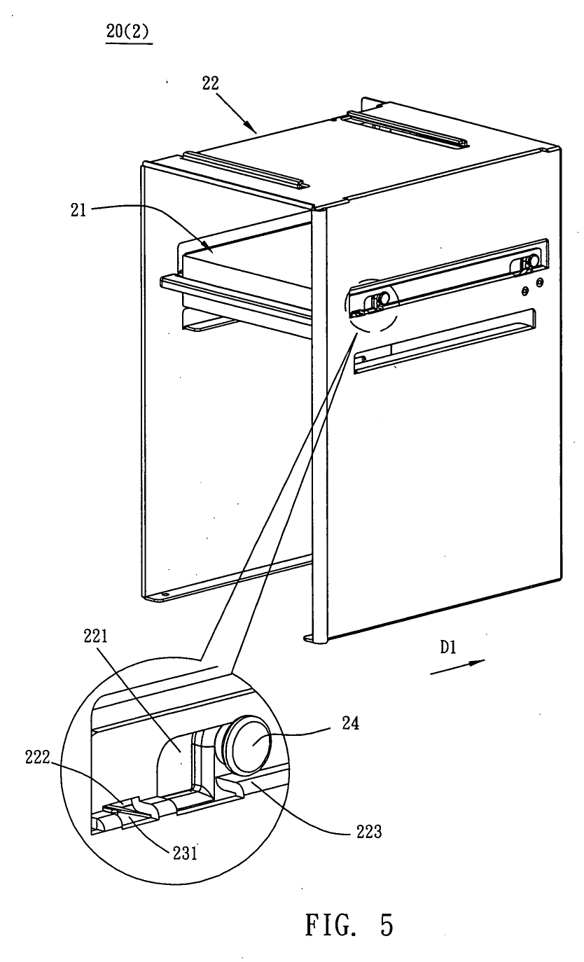

As shown in FIG. 5, after the fixing member 24 enters the first opening 221, the engaging portion 231 engages with the second opening 222. Another part of the fixing member 24 is positioned at the limit portion 223. Therefore, the fixing member 24 is limited by the limit portion 223, and the detachable electronic assembly 21 cannot move in the direction perpendicular to the first direction D1. The engaging portion 231 of the latch member 23 engages with the second opening 222. Therefore, the detachable electronic assembly 21 also cannot move in the direction perpendicular to the first direction D1. The detachable electronic assembly 21 is thus fixed in the casing 22.

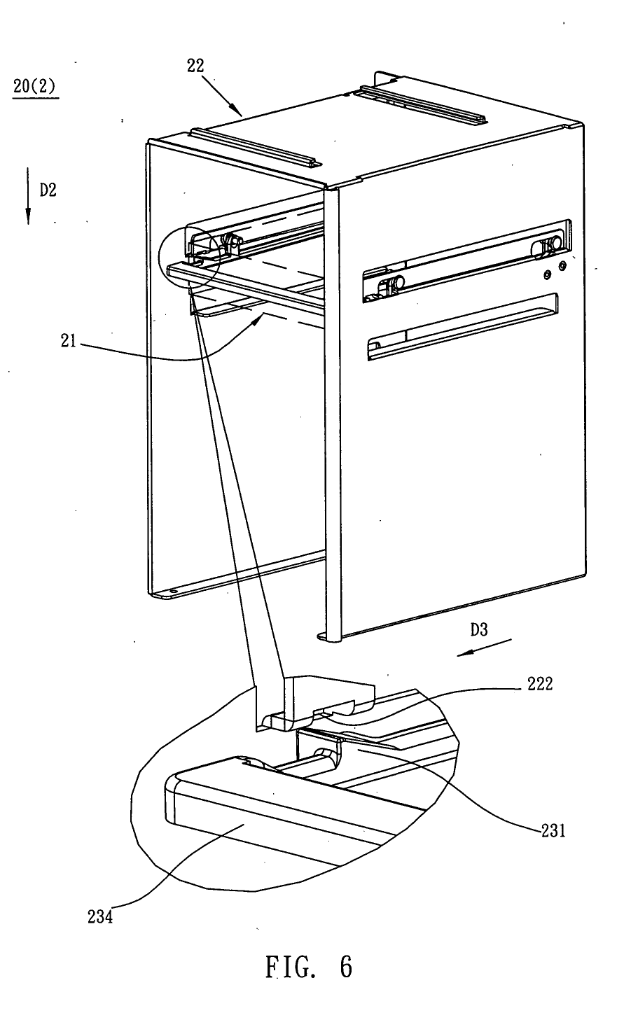

Referring to FIG. 6, to release the detachable electronic assembly 21, the user exerts an external force in a second direction D2 on a holding portion 234. Due to the elasticity, the engaging portion 231 departs from the second opening 222. The user can thus draw the detachable electronic assembly 21 along a third direction D3 opposite to the first direction D1, thereby releasing the detachable electronic assembly 21 from the casing 22.

Next, please refer to FIGS. 2 to 6 for illustrating an electronic apparatus according to a preferred embodiment of the invention.

With reference to FIG. 2, an electronic apparatus 2 includes a detachable electronic assembly 21, a casing 22, a latch member 23, and at least one fixing member 24.

The casing 22, the latch member 23, and the fixing member 24 can be called the latch structure 20.

The detachable electronic assembly 21 has at least one hole 211. The detachable electronic assembly 21 can be an HDD or an optical disk drive. In this embodiment, the detachable electronic assembly 21 is, for example, an HDD.

The casing 22 has at least a first opening 221, at least a second opening 222, and a limit portion 223. The limit portion 223 is adjacent to the first opening 221 and can be formed on the casing 22 by a punch process. In this embodiment, the casing 22 has several first openings 221 and several second openings 222, which are provided on both sides of the casing 22. The casing 22 can accommodate at least a detachable electronic assembly 21. In this embodiment, a single detachable electronic assembly 21, for example, is accommodated in the casing 22.

Besides, the casing 22 has at least a support bar 224, installed adjacent to the first opening 221 and the second opening 222. In this embodiment, the casing 22 has two supporting bars. 224. The detachable electronic assembly 21 can slide in the casing with the support of the supporting bars 224.

The latch member 23 is connected to the detachable electronic assembly 21. It has an engaging portion 231 and at least a fixing portion 232. As shown in FIG. 3, the engaging portion 231 has a slant surface 233. When the detachable electronic assembly 21 moves along a first direction D1, the engaging portion 231 engages with the second opening 222 via the slant surface 233.

With reference to FIGS. 2 and 3, one part of the fixing member 24 passes through the fixing portion 232 and the hole 211 of the detachable electronic assembly 21 to fix the latch member 23 to the detachable electronic assembly 21. In this embodiment, the fixing portion 232 can be a hole 211 and the fixing member 24 can be a screw or rivet.

Referring to FIGS. 2 and 4 again, the latch structure 20 of the embodiment further includes a guiding member 25 provided adjacent to the first opening 221. It can be made of a metal, plastic or rubber. The guiding member 25 has a guiding surface 251. When the detachable electronic assembly 21 moves along the first direction D1, the fixing member 24 also moves. Once the fixing member 24 touches the guiding surface 251, the fixing member-24 enters the first opening 221 along the guiding surface 251. The first direction D1 and the guiding surface 251 subtend an angle. Therefore, the detachable electronic assembly 21 is lifted as the fixing member 24 moves along the guiding surface 251.

As shown in FIG. 5, after the fixing member 24 enters the first opening 221, the engaging portion 231 engages with the second opening 222. Another part of the fixing member 24 is positioned at the limit portion 223. Therefore, the fixing member 24 is limited by the limit portion 223, and the detachable electronic assembly 21 cannot move in the direction perpendicular to the first direction D1. The engaging portion 231 of the latch member 23 engages with the second opening 222. Therefore, the detachable electronic assembly 21 also cannot move in the direction perpendicular to the first direction D1. The detachable electronic assembly 21 is thus fixed in the casing 22.

Referring to FIG. 6, to release the detachable electronic assembly 21, the user exerts an external force in a second direction D2 on a holding portion 234. Due to the elasticity, the engaging portion 231 departs from the second opening 222. The user can thus draw the detachable electronic assembly 21 along a third direction D3 opposite to the first direction D1, thereby releasing the detachable electronic assembly 21 from the casing 22.

In summary, the electronic apparatus and its latch structure of the invention utilize a fixing member and a latch member to fix the detachable electronic assembly on the casing. In comparison with the prior art, when the detachable electronic assembly is pushed into the casing, the fixing member on the detachable electronic assembly enters the first opening, positioned on the limit portion. At the same time, the engaging portion on the latch member enters the second opening, fixing the detachable electronic assembly inside the casing. Since the invention reduces or even avoids the use of screws, a lot of time for mounting screws and the cost for them can be saved. Moreover, the user can remove the detachable electronic assembly simply by pressing the latch member. Thus, the user does not need to mount dismount screws when fixing or releasing the detachable electronic assembly. It is very convenient and simple. One also does not need to worry if he or she loses the screws for fixing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A latch structure for fixing a detachable electronic assembly with at least one hole, the latch structure comprising:
a casing having at least a first opening, at least a second opening and a limit portion adjacent to the first opening;
a latch member having an engaging portion and at least a fixing portion; and
at least a fixing member, wherein one part of the fixing member passes through the fixing portion and the hole to fix the latch member on the detachable electronic assembly, and another part of the fixing member is positioned at the limit portion when the engaging portion engages with the second opening.

2. The latch structure of claim 1, further comprising a guiding member adjacent to the first opening, wherein the guiding member has a guiding surface, and when the detachable electronic assembly moves along a first direction, the fixing member enters the first opening along the guiding surface.

3. The latch structure of claim 1, wherein the first direction and the guiding surface subtends an angle.

4. The latch structure of claim 1, wherein the casing has at least a supporting bar adjacent to the first opening and the second opening for the detachable electronic assembly to move thereon.

5. The latch structure of claim 2, wherein the engaging portion has a slant surface, and when the detachable electronic assembly moves along the first direction, the engaging portion engages with the second opening using the slant surface.

6. The latch structure of claim 1, wherein when an external force is exerted along a second direction to press on a holding portion of the latch member, the engaging portion departs from the second opening and the detachable electronic assembly moves along a third direction opposite to the first direction.

7. The latch structure of claim 1, wherein the fixing member is a screw.

8. The latch structure of claim 1, wherein the fixing member is a rivet.

9. The latch structure of claim 1, wherein the detachable electronic assembly is a hard disk drive (HDD).

10. An electronic apparatus comprising:
a detachable electronic assembly with at least one hole;
a casing having at least a first opening, at least a second opening and a limit portion adjacent to the first opening;
a latch member having an engaging portion and at least a fixing portion; and
at least a fixing member, wherein one part of the fixing member passes through the fixing portion and the hole to fix the latch member on the detachable electronic assembly and another part of the fixing member is positioned at the limit portion when the engaging portion engages with the second opening.

11. The electronic apparatus of claim 10, further comprising a guiding member adjacent to the first opening, wherein the guiding member has a guiding surface, and when the detachable electronic assembly moves along a first direction, the fixing member enters the first opening along the guiding surface.

12. The electronic apparatus of claim 10, wherein the first direction and the guiding surface subtend an angle.

13. The electronic apparatus of claim 10, wherein the casing has at least a supporting bar adjacent to the first opening and the second opening for the detachable electronic assembly to move thereon.

14. The electronic apparatus of claim 11, wherein the engaging portion has a slant surface, and when the detachable electronic assembly moves along the first direction, the engaging portion engages with the second opening using the slant surface.

15. The electronic apparatus of claim 10, wherein when an external force is exerted along a second direction to press on a holding portion of the latch member, the engaging portion departs from the second opening and the detachable electronic assembly moves along a third direction opposite to the first direction.

16. The electronic apparatus of claim 10, wherein the fixing member is a screw.

17. The electronic apparatus of claim 10, wherein the fixing member is a rivet.

18. The electronic apparatus of claim 10, wherein the detachable electronic assembly is a hard disk drive (HDD).
